(19) United States
(12) Patent Application Publication
(10) Pub. No.: US 2025/0332761 A1
(43) Pub. Date: Oct. 30, 2025

(54) Dust Abatement Vacuum Hood for a Flush-Cut Concrete Saw

(71) Applicant: PacificEmprise LLC., Burlingame, CA (US)

(72) Inventor: Marc Cussenot, San Francisco, CA (US)

(73) Assignee: PacificEmprise LLC., Burlingame, CA (US)

(21) Appl. No.: 19/186,850

(22) Filed: Apr. 23, 2025

Related U.S. Application Data
(60) Provisional application No. 63/638,201, filed on Apr. 24, 2024.

(51) Int. Cl. B28D 7/02; B28D 1/04

(52) U.S. Cl. CPC B28D 7/02; B28D 1/045

(57) ABSTRACT

A vacuum hood used with a flush-cut concrete saw to abate the dust, debris and concrete particulate. The vacuum hood includes a rigid blade guard having an integrated vacuum conduit and a pliable cover shroud with an internal reinforcing conduit extension supporting the shroud around the inlet of the vacuum conduit. The pliable shroud partially covers the blade guard and drapes over the work area to create a ground seal to prevent dust and particulate from escaping under and around the blade guards. Unlike rigid guards and shrouds, the pliable shroud can bend and follow the contours and obstacles of the work area without allowing dust and particulate to escape. The conduit extension helps prevent the pliable shroud from collapsing onto itself around the inlet end of the vacuum conduit regardless of the vacuum drawn by the vacuum source.

This application claims the benefit of U.S. Provisional Patent Application, Serial No. 63/638,201 filed Apr. 24, 2024.

This invention relates to a dust abatement vacuum hood for use with handheld, flush-cutting concrete saws.

### BACKGROUND OF THE INVENTION

Trip hazards on sidewalks created by uneven lifting and settling of contiguous sections of concrete sidewalks present a safety hazard for users and a liability for municipalities. “Flush-cutting” is one of the most effective methods for removing trip hazards from concrete sidewalks. Flush-cutting involves using a specialized right-angle grinder having a specialized hub and cutting blade, commonly referred to as a flush-cut saw or horizontal concrete saw, to cut and chamfer a portion of one or both adjacent concrete slabs, thereby removing the trip hazard from a concrete sidewalk. The flush-cut operation and apparatus are disclosed in U.S. Pat. Nos. 6,827,074; 6,896,604; 7,000,606; 7,143,760; 7,201,644; and 7,402,095.

While the flush-cut method is useful in reducing or eliminating trip hazards, the process of cutting the concrete slabs may generate large amounts of dust, debris and concrete particulate. Concrete particulate is a mixture of hydrated (i.e., crystalized) cement, aggregate (gravel) and silica sand. Inhaling the dust, debris and concrete particulate from flush cutting concrete slabs is a significant health hazard. Statistical evidence has shown that the breathing of silica dust can cause lung cancer. Consequently, it is essential that the saw operator and those in the vicinity of the work be protected from the dust. Although it is fairly simple to provide the saw operator with eye protection and a dust mask, it is more difficult to ensure that all who are near the work area receive protection. Furthermore, as masks are typically not 100 percent effective, dust abatement is a better solution.

### SUMMARY OF THE INVENTION

The vacuum hood of this invention is used with a concrete saw to abate the dust and concrete particulate generated by the saw in flush-cut operations. The vacuum hood includes a rigid blade guard having an integrated vacuum conduit and a pliable cover shroud with an internal reinforcing conduit extension supporting the shroud around the inlet of the vacuum conduit. The pliable shroud partially covers the blade guard and drapes over the work area to create a ground seal to prevent dust and particulate from escaping under and around the blade guards. Unlike rigid guards and shrouds, the pliable shroud can bend and follow the contours and obstacles of the work area without allowing dust and particulate to escape. The conduit extension helps prevent the pliable shroud from collapsing onto itself around the inlet end of the vacuum conduit regardless of the vacuum drawn by the vacuum source.

The above described features and advantages, as well as others, will become more readily apparent to those of ordinary skill in the art by reference to the following detailed 9 description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary embodiment of the vacuum hood of this invention;

FIG. 2 is a top perspective view of the vacuum hood mounted of FIG. 1 attached to a conventional concrete saw;

FIG. 3 is a perspective view of the vacuum hood and concrete saw of FIG. 2 in use to flush cut a section of a concrete sidewalk;

FIG. 4 is a bottom view of the vacuum hood and concrete saw of FIG. 2;

FIG. 5 is a partial side cross-sectional view of the vacuum hood of FIG. 2 taken along the longitudinal axis of the concrete saw;

FIG. 6 is a partial front cross-sectional view of the vacuum hood and concrete saw taken along the longitudinal axis of the vacuum conduit of the hood; and

FIG. 7 is a top view with the shroud folded back over itself and secured to the concrete saw.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

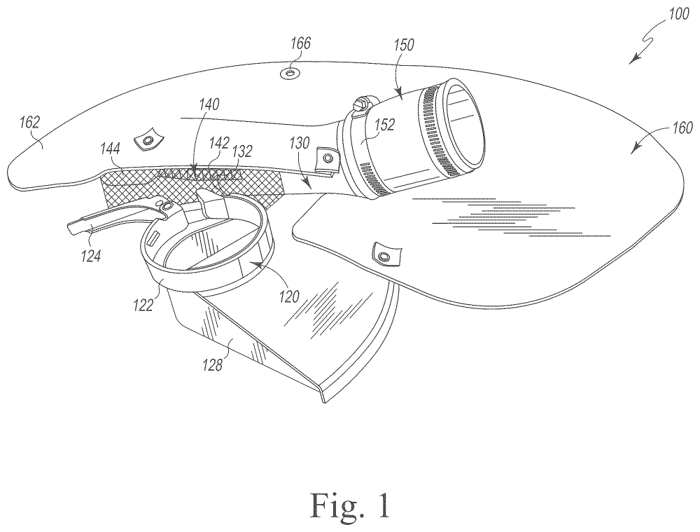

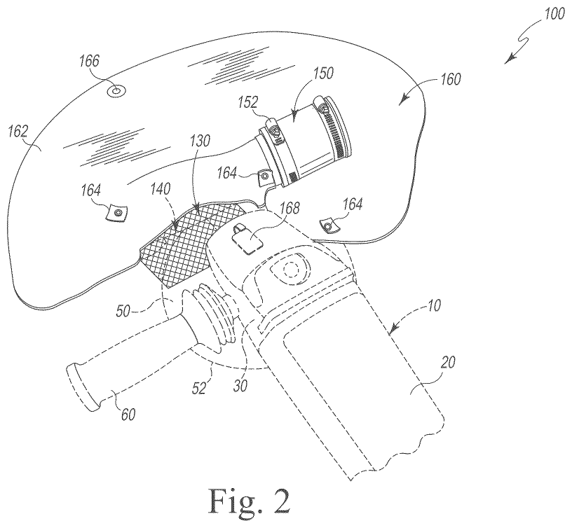

Referring now to the drawings, FIGS. 1-7 illustrate an exemplary embodiment of the vacuum hood of this invention, which is designated generally as reference numeral 100. Vacuum hood 100 is used with a conventional concrete saw 10 to abate the dust, debris and concrete particulate generated by the saw from escaping into the environment. Vacuum hood 100 connects a conventional concrete saw to a vacuum source for flush-cutting concrete to repair trip hazards in concrete sidewalks and the like. The vacuum source used in this invention typically takes the form of a wet/dry vacuum cleaner (not shown) or similar device connected to the hood by a vacuum hose 4. While intended for use with flush-cut concrete saws, the vacuum hood of this invention may be readily adapted for other saw and grinders and other dust abatement applications.

### Concrete Saw

Vacuum hood 100 is shown attached to a conventional electric powered concrete saw 10. Concrete saw 10 is illustrated as a right-angle grinder/saw modified with a suitable hub and blade for flush-cutting concrete slabs 2. Concrete saw 10 includes a motor housing 20, which encloses an electric drive motor (not shown), a right-angle gear train assembly 30, a rotating attachment hub 40, and a circular rotary blade 50. Concrete saw 10 also includes a T-handle 60 extending from gear train assembly 30 perpendicular to the longitudinal axis of motor housing 20.

Gear train assembly 30 is attached to the front of motor housing 20 and includes a cylindrical trunnion 32 that acts as a connecting interface for vacuum hood 100. Gear train assembly 30 couples to the horizontal output shaft of the saw motor, and includes a generally vertical, rotatably-powered, threaded output spindle (not shown). The output spindle extends axially from trunnion 32, which is offset and axially perpendicular to the longitudinal axis of the horizontal output shaft of the saw motor. Attachment hub 40 connects circular blade 50 to the output spindle of the gear train assembly 30 and spaces the blade away from motor housing 20. Hub 40 rotates with blade 50 with the rotation of the output spindle.

Saw blade 50 is a circular diamond-grit-edged rotary blade of the type commonly used to cut concrete. Saw blade 50 is generally composed of a metal matrix which incorporates diamond grit throughout, which enables the blade, when rotating, to cut through “green” or seasoned concrete. Generally, blade 50 has a new diameter of approximately 8 inches (about 203 mm), and the blade core has a thickness of about 0.55 inches. Blade 50 has a peripheral cutting edge 52.

### Vacuum Hood

Vacuum hood 100 generally includes a rigid blade guard 110, a mounting collar 120, a vacuum conduit 130, a conduit extension 140, hose coupling 150, and a pliable cover skirt or shroud 160. These components are describe as separate unique component of the hood. In certain exemplary embodiments, these components may be assembled as separate individual parts assembled and interconnected by various mechanical means. In other exemplary embodiments, one or more components may be integrated together being cast, molded or bonded together as single composite component.

Blade guard 110 functions as a protective shield guard for rotating blade 50 of concrete saw 10, but also as the base structural platform of the other vacuum hood components. As a protective shield, blade guard 110 is formed, cast or molded from suitable metal or rigid polymer material. Blade guard 110 has a semicircular configuration and is dimensioned to partially cover blade 50 when attached to concrete saw 10. When attached to concrete saw 10, blade guard 110 covers the blade 50 along the right side of concrete saw 10. Blade guard 110 has an angled arcuate top 112 and down turned acruate peripheral flange 114 that extends over cutting edge 52 of blade 50. Blade guard 110 also has an end wall 128 that partially encloses the area above the saw blade 50 opposite shroud 160.

Collar clamp 120 detachably mounts blade guard 110 to concrete saw 10. As shown, collar clamp 120 is an integral element of blade guard 110. Collar 120 includes an annular ring 122 for receiving trunnion 32 of concrete saw 10 and an over-center lever member 124, which tightens the ring around the trunnion to secure blade guard 110 to concrete saw 10. Ring 22 extends upward from guard top 112 and is concentric with peripheral flange 114. It should be noted that blade guard 110 may be detachably connected to concrete saw 10 using a variety of mechanical methods In other embodiments of the vacuum hood of this invention.

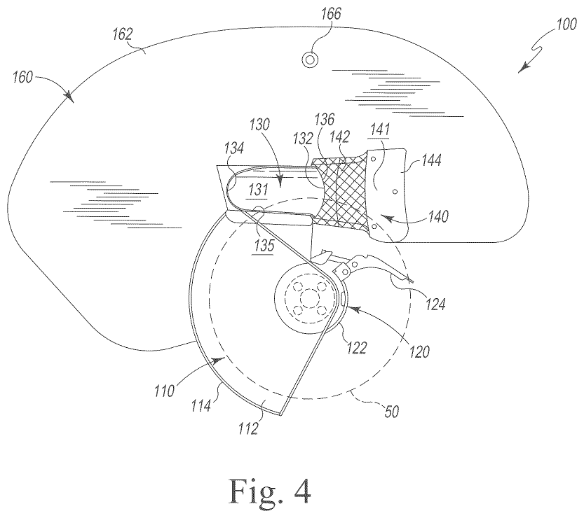

As best shown in FIG. 4, vacuum conduit 130 is a length of cylindrical tubing bonded, welded or otherwise directly cast or molded as an integral part of blade guard 110. As an integral part of blade guard 110, vacuum conduit 130 is constructed or composed of the same or similar rigid material as blade guard 110. Vacuum conduit 130 oriented with respect to blade guard 110 to extend tangentially to the peripheral flange 114 at the distal end of the guard. Vacuum conduit 130 has an open inlet end 132 and an opposed hose end 134 defining an internal passage 131 there between. Inlet end 132 of vacuum conduit 130 has an angled annular edge 136 positioned past the left side of the distal end of blade guard 110 and spaced above saw blade 50. The bottom surface of vacuum conduit 130 at inlet end 132 is cut back to form a bottom opening portion 135. Hose end 134 of vacuum conduit 130 extends over the rights side of blade guard 110.

Conduit extension 140 mounts to inlet end 132 of vacuum conduit 130. Conduit extension 140 supports shroud 160 to form an open space or “dust pocket” 141 forward of and in open fluid communication with inlet end 132 and bottom opening 135 of vacuum conduit 130. Conduit extension 140 includes a flexible arced mouth section 142 and a more planar reinforcement section 144. Mouth section 142 is an arched member that tapers or transitions from the conduit end to a more planar contour at the reinforcement end. Generally, mouth section 142 is formed or fabricated from a cut down section of fiber reinforced hose dimensioned to fit onto inlet end 132 of vacuum conduit 130. Mouth section 142 forms the three dimensional space of dust pocket 141. Reinforcement section 142 is generally a flat metal or rigid polymer piece attached to mouth section 142. Reinforcement section 142 is affixed to shroud 160 and provides support for dust pocket 141.

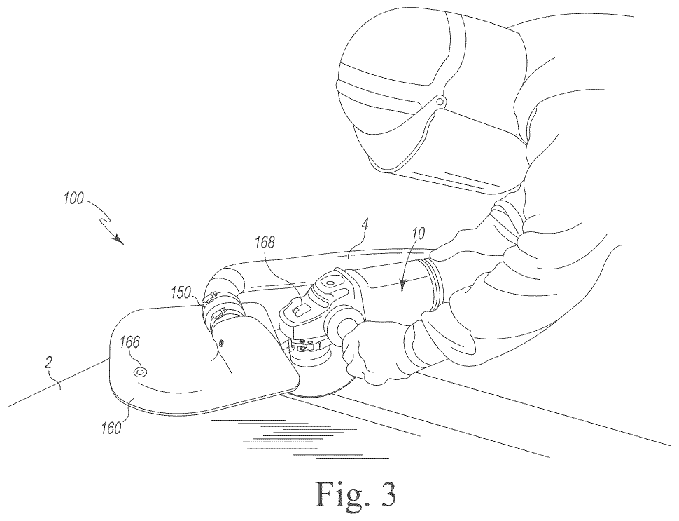

Hose coupling 150 is connected to hose end 134 of vacuum conduit 130 and connects vacuum hood 100 to vacuum hose 4 (FIG. 3). As shown, hose coupling 150 takes the form of a rubber tube secured to vacuum conduit 130 by a hose clamp 152. A second hose clamp 152 can be used to secure vacuum hose 4 to hose coupling 150 (not shown).

Shroud 160 partially covers blade guard 110 but more importantly, generally drapes over and encloses the work area of the concrete slab around cutting edge 52 of blade 50 including dust pocket 141. Shroud 160 helps contain the dust and concrete particulate from escaping under vacuum hood 100 before being drawn through vacuum conduit 130 by the vacuum source. Shroud 160 is cut or formed from a sheet of synthetic rubber, such as ethylene propylene diene monomer (“EPDM”) or similar material. The shroud material is selected to be durable and resilient, but pliable enough to drape over and around the surface of the particular work area of the concrete slab.

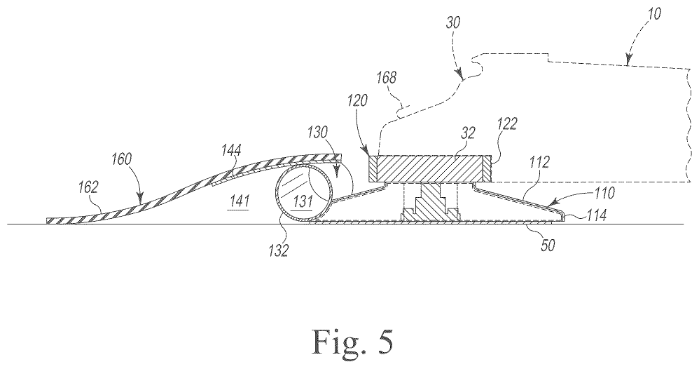

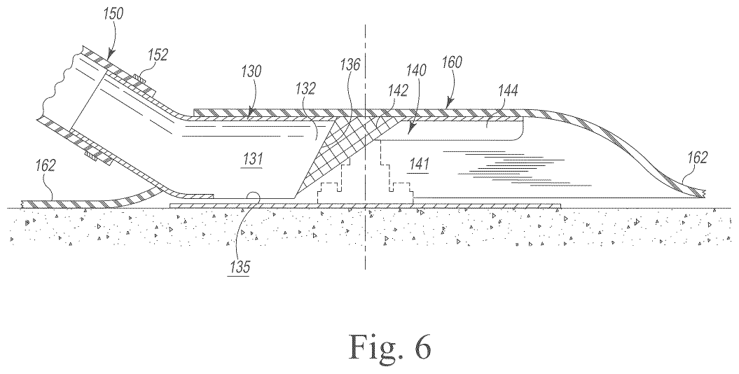

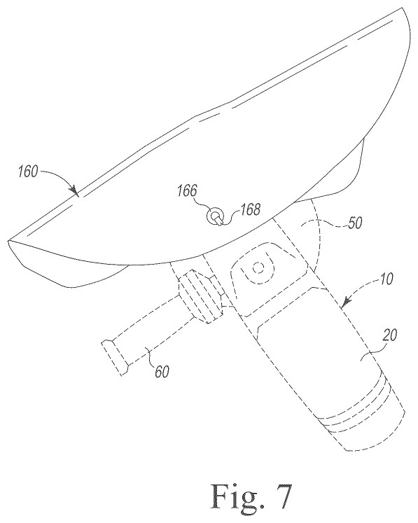

As best shown in FIGS. 1-4, shroud 160 has a generally semi-circular shape and dimension to extend radially past the periphery of blade guard 110 and forward of concrete saw 10. Shroud 160 extends forward of concrete saw 10 at the 12 o'clock position in a generally semi-circular arc, thereby overlying the work area of a concrete slab to be flush-cut. Shroud 160 extends forward and to the right side past the outer extreme of blade guard 110. Shroud 160 is tightly contoured to wrap over and around inlet end 132 of vacuum conduit 130 and conduit extension 140 and under the hose end 134 and hose coupliing 150. While raised and contoured around vacuum conduit 130, and conduit extension 140, shroud 160 has a flat peripheral edge 162 that tucks or extends under hose coupling 150. Shroud 160 is affixed to blade guard 110, vacuum conduit 130 and conduit extension 140 by common fasteners 162, such as screws and square washers. Conduit extension 140 provides structural support to shroud 160 and ensures that the shroud doesn't collapse under vacuum force into dust pocket 141 around inlet end 132 of vacuum conduit 130 retarding the flow of dust and concrete particulate into vacuum conduit 130 (FIGS. 5 and 6). Shroud 160 also includes an eyelet 164 located adjacent its forward distal edge that allows the front of the shroud to be folded over itself and secured to a hook member 166 attached to the top of concrete saw 10 (FIG. 7).

In use during a flush-cut operation, vacuum hood 100 is mounted to concrete saw 10 and the operator manipulates concrete saw 100 to cut a chamfer in the concrete slab. Shroud 160 drapes over the immediate work area of the concrete slab being flush-cut. The peripheral edge 162 of shroud 160 lies flat against the concrete slab to partially enclose the work area where the blade generates the dust and concrete particulate in the flush-cut operation. As best shown in FIGS. 5 and 6, cutting edge 52 of blade 50 is positioned directly over inlet vacuum chamber 141 and slightly to the right of open inlet end 132 and open bottom 135 of vacuum conduit 130. Concrete saws 10 turns blade 50 in a clockwise direction, which projects dust and concrete particulate leftward into dust pocket 141 and passage 131 of vacuum conduit 130. Dust and concrete particulate are evacuated from vacuum hood 100 through vacuum conduit 130 into vacuum hose 4 by the vacuum source (not shown). The engagement of the pliable peripheral edge 62 of shroud 160 against the slab around the work area prevents dust and concrete particulate from escaping under and around the vacuum hood 100. The pliable shroud also allows the operator to safely and easily manipulate concrete saw 10 over the concrete slabs close to and around obstacles, such as posts, corners and edges without removing vacuum hood 100 from the concrete saw. When necessary, the peripheral edge of shroud 160 can be lifted and secured back onto concrete saw 10 using eyelet 166 and hook 168 to visually expose more of the work area to the operator. End wall 128 helps funnel the dust that is between blade 50 and blade guard 110 into vacuum conduit 130, instead of exiting out on the other side of shroud 100. End wall 128 also protects hub 40 from wear and tear when cutting deep into the concrete.

One skilled in the art will note that the vacuum hood of this invention provides several advantages. The vacuum hood of this invention provides improved dust abatement for concrete saws in flush-cut operation. The vacuum hood conveniently mounts to conventional concrete saws and integrates the safety feature of a traditional blade guard into vacuum inlet features of a dust abatement system. The compact, light weight design of the vacuum hood easily mounts to concrete saws and allows blades to be readily replaced without removing the vacuum hood. The design also allows the operators an unobstructed view of the blade and cut line on the slab during the flush-cut operation.

The pliable shroud of this invention covers the blade guard and drapes over the work area to create a ground seal to prevent dust and particulate from escaping under and around the blade guards. Unlike rigid guards and shrouds, the pliable shroud can bend and follow the contours and obstacles of the work area without allowing dust and particulate to escape. Improving the dust seal around the work area improves the efficiency of the vacuum source. The conduit extension help prevent the pliable shroud from collapsing onto itself around the inlet end of the vacuum conduit regardless of the vacuum drawn by the vacuum source.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A dust abatement vacuum hood for use with a concrete saw and a vacuum source, where the concrete saw includes a motor housing, a gear assembly with a cylindrical hub, and a rotating circular blade mounted to the gear assembly and underlying the hub, and the vacuum source includes an elongated hose, the vacuum hood comprising:
a rigid blade guard adapted to detachably mount to the hub of the concrete saw; and
a pliable shroud mounted to the blade guard overlying the blade guard and a work area of the concrete saw forward of the blade for enclosing the work area to prevent dust from escaping the work area,
the blade guard having a semi-circular peripheral edge with a distal forward end thereof, the blade guard includes an integral hollow vacuum conduit extending tangentially to the peripheral edge at the distal forward end.

2. The vacuum hood of claim 1 wherein the vacuum conduit includes an open inlet end and an open hose end defining an open conduit passage there between.

3. The vacuum hood of claim 1 wherein the vacuum conduit has a bottom opening therein in fluid communication with the conduit passage.

4. The vacuum hood of claim 2 wherein the shroud extends over and encloses the inlet end of the vacuum conduit forward of the inlet end to form an open dust pocket in fluid communication with the conduit passage.

5. The vacuum hood of claim 4 wherein the shroud includes a conduit extension affixed to the inlet end of the vacuum conduit for supporting the shroud over the open dust pocket.

6. The vacuum hood of claim 1 wherein the blade guard is mountable to the concrete saw so that the blade guard is positioned to one side of the concrete saw.

7. The vacuum hood of claim 1 and an attachment member for connecting the blade guard to the concrete saw.

8. The vacuum hood of claim 7 wherein the attachment member includes a collar part extending from the blade guard for receiving the hub.

9. The vacuum hood of claim 1 and a hose coupling connected to the hose end of the vacuum conduit for connecting the vacuum hood to the vacuum source.

10. A dust abatement vacuum hood for use with a concrete saw and a vacuum source, where the concrete saw includes a motor housing, a gear assembly with a cylindrical hub, and a rotating circular blade mounted to the gear assembly and underlying the hub, and the vacuum source includes an elongated hose, the vacuum hood comprising:
a rigid blade guard adapted to detachably mount to the hub of the concrete saw;
a pliable shroud mounted to the blade guard overlying the blade guard and a work area of the concrete saw forward of the blade for enclosing the work area to prevent dust from escaping the work area; and
a hose coupling for connecting the vacuum hood to the vacuum source,
the blade guard having a semi-circular peripheral edge with a distal forward end thereof, the blade guard includes an integral hollow vacuum conduit extending tangentially to the peripheral edge at the distal forward end,
the blade guard includes an attachment member for connecting the blade guard to the concrete saw so that the blade guard is positioned to one side of the concrete saw, the attachment member includes a collar part extending from the blade guard for receiving the hub,
the vacuum conduit includes an open inlet end and an open hose end defining an open conduit passage there between, the vacuum conduit also has a bottom opening therein in fluid communication with the conduit passage,
the shroud extends over and encloses the inlet end of the vacuum conduit forward of the inlet end to form an open dust pocket in fluid communication with the conduit passage, the shroud includes a conduit extension affixed to the inlet end of the vacuum conduit for supporting the shroud over the open dust pocket.
